(19) United States
(12) Patent Application Publication
(10) Pub. No.: US 2019/0023117 A1
(43) Pub. Date: Jan. 24, 2019

(54) VEHICLE WITH RIGID REAR AXLE DIRECT ELECTRIC DRIVE

(71) Applicant: FORD GLOBAL TECHNOLOGIES, LLC, Dearborn, MI (US)

(72) Inventors: Peter Christoph WOLFF, Aachen (DE); Ralf HINTZEN, Aachen (DE)

(73) Assignee: FORD GLOBAL TECHNOLOGIES, LLC, Dearborn, MI (US)

(21) Appl. No.: 16/036,426

(22) Filed: Jul. 16, 2018

(30) Foreign Application Priority Data
Jul. 21, 2017 (DE) 10 2017 212 545.4

(51) Int. Cl. B60K 6/52; F16H 3/00; B60L 15/20; B60G 11/04; B60K 17/16; B60K 17/12; F16H 48/36

(52) U.S. Cl. CPC B60K 6/52; F16H 3/006; B60L 15/2036; B60K 2001/001; B60K 17/16; B60K 17/12; F16H 48/36; B60G 11/04

(57) ABSTRACT

A vehicle includes a body, an internal combustion engine, a traction battery, a front axle connecting two front wheels with at least one of the two front wheels drivingly coupled to the internal combustion engine, a rear axle connecting two rear wheels and carried by two leaf spring units, each leaf spring unit being pivotably connected at one end to the body and at another end to a connection arm pivotably connected to the body, wherein the rear axle includes two driveshafts connecting the rear wheels, and a drive unit supported by the rear axle to be self-supporting relative to the body. The drive unit includes an electric motor coupled to the traction battery and a differential mechanically coupled to the two driveshafts and the electric motor. The rear axle is mechanically uncoupled from the internal combustion engine.

### CROSS-REFERENCE TO RELATED APPLICATIONS

This application claims foreign priority benefits under 35 U.S.C. § 119(a)-(d) to DE Application 10 2017 212 545.4 filed Jul. 21, 2017, which is hereby incorporated by reference in its entirety.

### TECHNICAL FIELD

The disclosure relates to a vehicle having an electric motor directly driving a rear axle with both the electric motor and the rear axle coupled to the vehicle by leaf spring units.

### BACKGROUND

In the case of motor vehicles, a huge variety of suspensions for the vehicle wheels are known in the art. In particular, a distinction can be made between the single-wheel suspension which is currently used almost exclusively in passenger cars and the rigid-axle suspension used mainly with the rear axles of commercial vehicles. In the latter case, the two wheels on either side sit on a single continuous axle which is normally spring-mounted with respect to the vehicle body via leaf springs or control arms.

A typical design of this kind is a so-called Hotchkiss drive, in which a continuous axle is supported on both sides on individual leaf springs or leaf spring assemblies which extend in the longitudinal direction of the vehicle. Each of the leaf springs is pivotably connected at a front end to the vehicle body, for example a long girder. At a rear end, the connection is made indirectly via connection arms or bracket elements which, on the one hand, are connected pivotably to the leaf spring and, on the other, are connected pivotably to the vehicle body. Connection arms or this kind normally extend roughly perpendicularly. Their function is to allow length compensation during deformation of the leaf springs.

The rear axle in this case may also be driven under certain circumstances, wherein a drive shaft leads from an internal combustion engine in the front part of the vehicle to a differential sitting on the axle via which the wheels on both sides are driven.

U.S. Pat. No. 8,673,068 B2 discloses a drive unit for a hybrid electric vehicle. The drive unit comprises a bevel pinion which has a drive connection to an energy source, a bevel gearwheel which engages with the bevel pinion and is aligned with an axle, a first drive shaft and a second drive shaft. Furthermore, the drive unit comprises a differential mechanism with an input fastened to the bevel gearwheel for the transmission of energy between the input and the first and second drive shaft, an electrical motor/generator with a rotor, and a planetary gear which has a drive connection to the input and the rotor, in order to transmit energy between the rotor and the input, so that a speed of the rotor is greater than a speed of the input.

U.S. Pat. No. 7,549,940 B2 discloses a power transmission device for a vehicle for transmitting a driving force from a drive source to a right and a left axle. The power transmission device comprises a housing, a planetary gear for reducing speed which is connected to the drive source, a differential which is arranged coaxially to the planetary gear and connected to the right and left axle, and an oil tank which is arranged in a lower region of the housing. The differential has a differential housing which is integrally configured with a planetary support of the planetary gear. The planetary support comprises a first and a second ring element which are spaced apart from one another axially, and also a plurality of connection portions for connecting the first and second ring elements, wherein the connection portions have a substantially V-shaped opening outward in the radial direction of the first and second ring element.

U.S. Pat. No. 7,713,164 B2 discloses a system for controlling a gearshift in a vehicle powertrain that drives a load. The system comprises a transmission which has an input shaft and an output shaft, an engine connected to the drive shaft; an electric machine connected to the drive shaft; an input clutch for alternately closing and opening a drive connection between the engine and the output; and a controller configured to reduce a torque capacity of the input clutch to a magnitude that produces a predetermined torque at the load, to release a drive connection between the current gear and the output shaft, to produce a drive connection between the target gear and the output shaft, and to use the electric machine to generate torque of a magnitude that produces the predetermined magnitude at the load.

U.S. Pat. No. 8,647,231 B2 discloses a method for operating a vehicle powertrain which includes the following: driving first wheels using an electric motor, using a second electric motor which is driven by an engine to produce synchronous speed at an input of a transmission having a desired gear engaged; engaging a clutch that connects said input and the engine; and using the engine and the transmission to drive second wheels.

US 2012/0022731 A1 discloses a powertrain for launching a vehicle. The powertrain comprises an engine, a generator which is driveably connected to the machine, a transmission which is driveably connected to a first set of wheels, a clutch for connecting and disconnecting the transmission and the engine, and also a battery which is electrically connected to the generator. An electric machine is driveably connected to a second set of wheels and electrically connected to the battery. A controller is configured to determine the presence of a vehicle launch condition and to operate the powertrain in a series-drive mode.

### SUMMARY

In view of the state of the art, as disclosed, the drive of a motor vehicle with a Hotchkiss drive offers opportunity for improvement. The problem addressed by the claimed subject matter is that of providing an improved drive for a motor vehicle with a Hotchkiss drive.

It should be pointed out that in the following description individually specified features and measures can be combined with one another in any technically meaningful manner and other embodiments disclosed. The description characterizes and specifies representative embodiments of the invention additionally in connection with the Figures in particular.

In one embodiment, a hybrid motor vehicle is a two-track road vehicle which normally has at least four wheels, e.g. a lorry or truck, van, or passenger car. The motor vehicle has a rear axle that connects two wheels. Consequently, it is a rigid axle on which both wheels are arranged. In this case, the rear axle is carried by two leaf suspension units. Each leaf spring unit in this case is used to support the rear axle in such a manner that spring compression is possible. The leaf spring unit extends along a vehicle's longitudinal axis (X-axis). On the one hand, at a front end the leaf spring unit is pivotably connected (via a first pivot axis) to the vehicle body. The leaf spring unit comprises at least one leaf spring, the shape of which may be differently configured depending on the particular embodiment. For example, it may be semi-elliptical, parabolic, wavelike, etc. A plurality of leaf springs may form one or a plurality of spring assemblies in this case. The leaf spring units normally run roughly in the direction of the longitudinal axis of the vehicle. The vehicle body may, in particular, be a chassis and/or a body of the vehicle. Each of the leaf spring units carries the rear axle, i.e. the rear axle rests at least indirectly on the leaf spring units (or vice versa).

On the other hand, at a rear end the leaf spring unit is pivotably connected (via a second pivot axis) to a connection arm which is in turn pivotably connected (via a third pivot axis) to the vehicle body. A plurality of connection arms may also be provided, or the one connection arm may be of multipart design. Each of the connection arms is preferably inherently rigid in design. In each case, the rear end of the leaf spring unit is movable with respect to the vehicle body due to the respective connection arm. In other words, while the front end is at least substantially positionally fixed with respect to the vehicle body and can only pivot about the first axle, the rear end can be displaced with respect to the vehicle body due to the indirect attachment via the connection arm. In this way, it is possible during compression of the leaf spring unit for the deformation thereof to be balanced. For example, a semi-elliptical leaf spring is elongated during compression, so that the distance between the two ends is greater. Normally, the first, second and third pivot axes extend parallel to the transverse axis (Y-axis) of the vehicle. In this case, the movements of the respective spring assembly take place within the X-Z plane. The basic design therefore corresponds to a Hotchkiss drive.

In this case, the rear axle has two drive shafts for the wheels and also a drive unit which is self-supporting with respect to the vehicle body and has an electric motor unit and also a differential coupled thereto connecting the drive shafts. The electric motor unit in this case has at least one electric motor which may be configured as an AC or DC motor, for example. The differential is coupled to the motor unit, which includes the possibility of it being uncouplable from time to time. “Coupled” in this case means that a driving force is transmitted from the motor unit to the differential. The two drive shafts transmit the driving force from the differential to the two wheels. The differential in this case may be any kind of gearing that allows independent rotation of the drive shafts, e.g. a bevel gear differential or spur gear differential. The motor unit and the differential in this case are part of a drive unit which is self-supporting with respect to the vehicle body. In other words, the drive unit is arranged on the rear axle and therefore connected only indirectly via the leaf spring units and the connection arms to the vehicle body. It is therefore movable with respect to the vehicle body within the framework of the spring deflection. It has been demonstrated in this case that a drive unit of this kind on the rear axle can be integrated without this having a noticeably negative impact on driving performance. There is also usually sufficient assembly space on the rear axle for the integration of a drive unit of this kind.

Through a drive unit of this kind, an independent electrical drive can be made available for the rear axle which can provide additional torque in certain situations, for example. However, the drive unit may also be used for engine or generator braking, for example, in order to support existing wheel braking, for example. There is no longer any need for mechanical force transmission to the rear axle, since the drive unit is arranged directly on the rear axle. Another advantage is the assembly space saving in relation to the space required for a high-voltage battery in the case of electric vehicles, since the drive system in the invention can be completely integrated in the axle. The body furthermore requires no additional suspension points for the drive, wherein in addition no floor reinforcements are necessary, in order to accommodate a heavy electric motor and support the torque thereof.

The drive unit preferably has at least one coupling by means of which at least one drive shaft can be uncoupled from the motor unit. This may of course be appropriate in driving situations in which the electric motor unit is out of operation, for example because there is currently no drive energy available. A coupling of this kind may, for example, be arranged between one of the drive shafts and the differential. By releasing the corresponding coupling, the wheel assigned to this drive shaft is uncoupled from the differential, as a result of which there is substantially no power transmission from the drive unit via the differential to the other drive shaft.

The drive unit may be relatively compact in design, even with a sufficiently robust electric motor unit configuration. In order to protect the motor unit and the differential more effectively from dirt, moisture and mechanical influences, the drive unit preferably has a drive housing in which the motor unit and the differential are arranged. The drive housing in this case to a certain extent forms a capsule which protects the components lying within. It may of course be made up of two or more parts. The aforementioned coupling may also be arranged within the housing, just as with other components.

Each drive shaft is preferably arranged at least partly in a shaft housing which is connected to the drive housing. A shaft housing of this kind normally surrounds the drive shaft concentrically over at least the greater part of its length and may, for example, also have one or a plurality of bearings, via which the drive shaft is rotatably mounted. It may also constitute protection for the bearings or the drive shaft against dirt or moisture. Since each drive shaft is attached to the differential located in the drive housing, the design described here, in which each shaft housing is connected to the drive housing, can always be achieved in principle. It could also be said that the drive housing and the two shaft housings form a housing group in which at least the plurality of the mechanical components responsible for driving the wheels is encapsulated.

In principle, a direct coupling of the motor unit to the differential is possible in such a manner, for example, that a gearwheel coupled directly to a shaft of the motor interacts with a gearwheel of the differential (normally with the planetary gear carrier). The motor unit is preferably coupled to the differential via a reduction gear. In this case, for example, a gearwheel of the engine can be coupled via a single, intermediate gearwheel of the reduction gear to the planetary gear carrier of the differential. More complex embodiments are of course also conceivable.

According to one embodiment, the motor vehicle has an internal combustion engine to drive a front axle, wherein the rear axle is mechanically uncoupled from the internal combustion engine. In other words, the internal combustion engine is mechanically couplable to the front axle, in order to drive said axle. By contrast, the rear axle is not mechanically coupled to the internal combustion engine, for example via a drive shaft or the like. However, the driving force of the rear axle may be indirectly generated by the internal combustion engine, for example in such a manner that the internal combustion engine is coupled to a generator which in turn supplies energy for the electrical motor unit.

Even if a direct coupling of the motor unit to a generator, as described above, is conceivable, it is advantageous for the vehicle to have at least one battery unit to supply energy to the motor unit. By means of this battery unit, which may exhibit one or a plurality of batteries, the motor unit has a permanent supply of energy available to it (depending on the charging state of the battery unit, of course). The battery unit is of course rechargeable, i.e. it could also be referred to as a storage battery unit. A battery unit of this kind may, as a modification to the coupling to a generator described above, to a certain extent be arranged in between, in such a manner that the generator charges the battery unit and the motor unit takes energy from the battery unit. However, the battery unit could also be provided independently of the existence of a generator of this kind, wherein it can be charged where necessary, for example, by connecting it to the mains power.

While the drive unit is arranged on the rear axle in a self-supporting manner with respect to the vehicle body and therefore follows the movements thereof during spring compression, it is preferable for the at least one battery unit to be fastened to the vehicle body. The reason for this is simply that high-performance batteries are generally heavy and comparatively large. An arrangement directly on the drive unit, in other words on the axle, would lead to a considerable increase in the unsprung mass and could also cause problems in relation to the assembly space in the region of the rear axle.

While the battery unit can be charged either by a generator which is assigned to an internal combustion engine or by a mains power supply, charging by the electric motor unit in recovery mode is also possible at least in part. In this case, the motor unit can be operated as a generator, in order to charge the at least one battery unit. For example, it may be provided that during a braking action there is an automatic energy recovery, in that there is partial braking by the motor unit as a generator, which therefore converts kinetic energy into electrical energy and stores this in the at least one battery unit. It would also be conceivable in certain situations for the rear axle to be drawn to a certain extent by the front axle and the internal combustion engine thereof, wherein the motor unit is driven via the wheels of the rear axle and produces energy for the battery unit as a generator.

Under certain circumstances it may be provided that the vehicle can be driven by the motor unit exclusively via the rear axle. In other words, an internal combustion engine can be completely dispensed with for driving the front axle or it may be provided in certain driving situations that the internal combustion engine is either left inoperative or is not coupled to the front axle and, instead of this, a drive takes place exclusively through the electric motor unit of the rear axle. It would also be conceivable for the internal combustion engine to be mechanically uncoupled from the front axle, but for the energy to be made available for the electrical motor unit via a generator (with or without a battery unit inserted).

Further advantageous details and effects of the claimed subject matter are explained in greater detail below with the help of an exemplary embodiment depicted in the figures.

### BRIEF DESCRIPTION OF THE DRAWINGS

FIG. 1 shows a schematic side view of a motor vehicle according to one or more embodiments;

FIG. 2 shows a schematic lower view of the vehicle from FIG. 1; and

FIG. 3 shows a schematic sectional representation of a drive unit of the vehicle from FIG. 1.

### DETAILED DESCRIPTION

As required, detailed embodiments are disclosed herein; however, it is to be understood that the disclosed embodiments are merely exemplary and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

In the different figures, the same parts are provided with the same reference numbers, which is why they are also usually described only once.

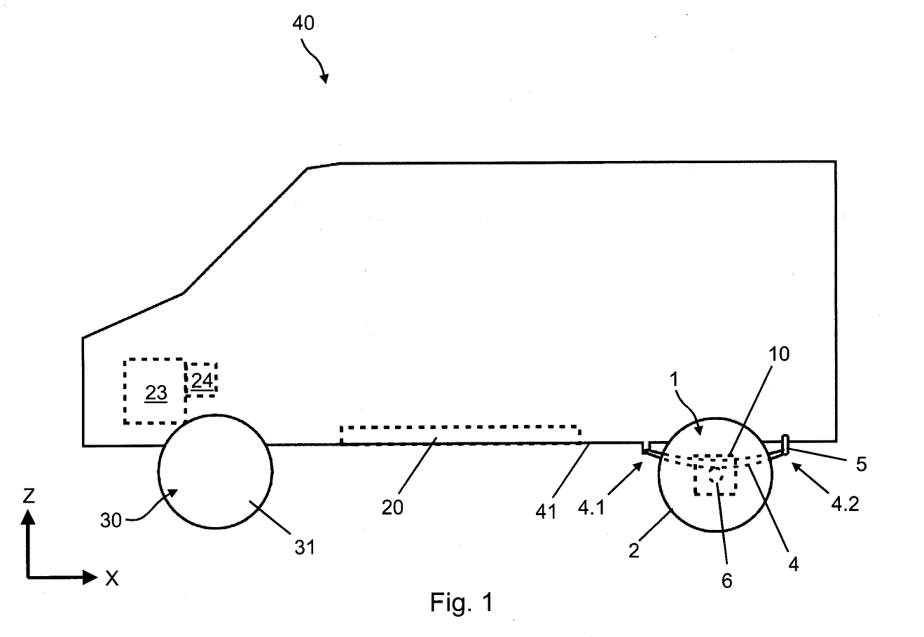

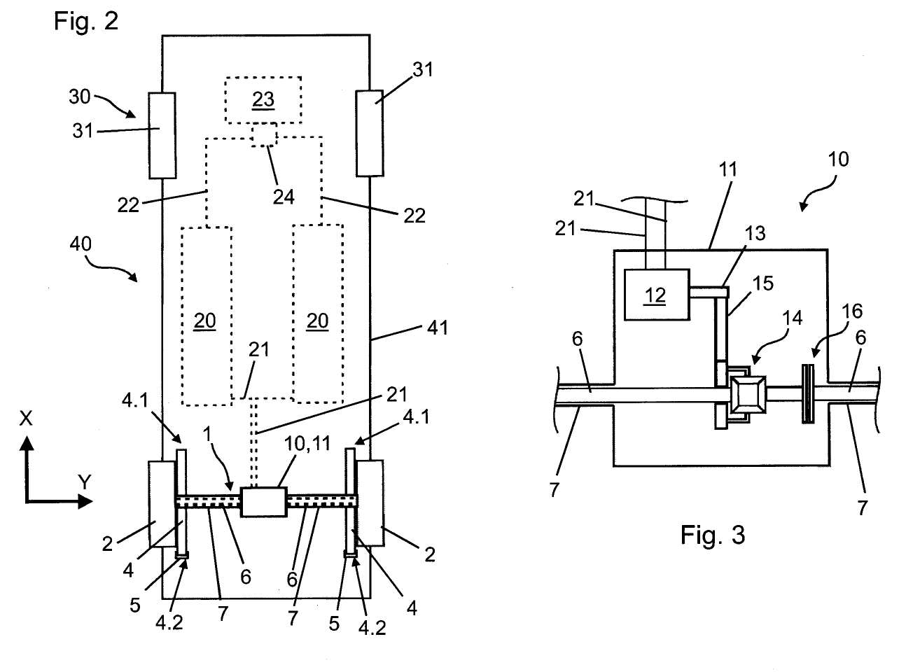

FIGS. 1 and 2 show different views of a motor vehicle 40 according to one embodiment, for example a van. The representation in this case is highly schematic and simplified. A rear axle 1 configured as a rigid axle which extends parallel to the Y-axis is fastened to two leaf springs 4 extending substantially in the direction of the X-axis, via which the rear axle 1 is fastened in a spring-mounted manner to a vehicle body 41, for example a vehicle chassis. The leaf springs 4 which are configured as semi-elliptical springs in the present case may, in particular, be made of spring steel or, where appropriate, of fiber-reinforced plastic. In the present case, they form leaf spring units which may also, alternatively, be configured as assemblies of multiple leaf springs. The rear axle 1 connects two wheels 2 arranged on either side.

At a front end 4.1, each leaf spring 4 is pivotably connected to the vehicle body 41. At a rear end 4.2, the leaf spring 4 in each case is pivotably connected to a connection arm 5 which, in turn, is pivotably connected to the vehicle body 41. In this case, the body shown therefore corresponds to a Hotchkiss drive. Overall, the connection arms 5 allow movement of the rear end 4.2 within the X-Z plane, to be more precise, a rotation about the pivot axis of the connection arm 5 with respect to the vehicle body 41, as a result of which the deformation of the leaf springs 4 during compression can be balanced.

The rear axle 1 has two drive shafts 6 for the two wheels 2 and also a drive unit 10 which is depicted as a detail in the sectional representation in FIG. 3. The representation in FIG. 3 is also highly schematic in this case. The drive unit 10 has a drive housing 11 which is used to protect various components from mechanical damage, dirt and moisture. An electric motor 12 is arranged within the housing 11 which interacts via a first gearwheel 13 with a second gearwheel 15 of a transmission gearing. The second gearwheel 15 in turn transmits the driving force of the electric motor 12 to a differential 14 which is configured as a bevel gear differential in the present case. By means of the differential 14, the driving force is transmitted to the respective drive shafts 6 which are rotatably arranged in shaft housings 7 which are connected to the drive housing 11. The drive shafts 6 can be uncoupled from the electric motor 12 via a coupling 16 and are then located to some extent in a self-supporting manner. The entire drive unit 10 is arranged on the rear axle 1 and is movable therewith in respect of the vehicle body 41 according to the spring deflection. In other words, the drive unit 10 is self-supporting with respect to the vehicle body 41.

The energy supply of the electric motor 12 is guaranteed via two first lines 21 which are connected to two battery units 20. The battery units 20 are arranged separately from the drive unit 10 on or within the vehicle body 41 and are therefore part of the sprung mass. Each battery unit 20 contains one or multiple storage batteries and is therefore rechargeable. The charging of the battery units 20 in this case may take place via two lines 22, on the one hand, which are fed by a generator 24 which is mechanically coupled to an internal combustion engine 23 of the motor vehicle 40. Normally, in addition, possibly also alternatively, for charging by the generator 24, the electric motor 12 can be operated as a generator during braking actions, for example, and electrical energy can be fed to the battery units 20 via the first lines 21. Apart from possible charging of the battery units 20, the internal combustion engine 23 is used as a mechanical drive for the wheels 31 of a front axle 30 of the motor vehicle 40. While it can indirectly (via the generator 24, the battery units 20 and the electric motor 12) provide energy for driving the rear axle 1, the rear axle 1 is mechanically uncoupled from the internal combustion engine 23.

Overall, running the vehicle 40 with four-wheel drive by means of the internal combustion engine 23 and also the electric motor 12 is possible. The electric motor 12 in this case may, for example, provide additional torque from time to time. It is of course also conceivable here for only the internal combustion engine 23 or also only the electric motor 12 to be occasionally used as the drive. The electric motor 12 may also be used for motor or generator braking of the wheels 2 on the rear axle 1.

Within the framework of the claimed subject matter, different variants of the embodiment shown in this case are conceivable. For example, the internal combustion engine 23 and the generator 24 could be completely dispensed with and the electric motor 12 could represent the single drive of the vehicle 40. In this case, the battery units 20 could, where necessary, be charged by connecting to a mains power supply. It would also be possible for the internal combustion engine 23 to be mechanically uncoupled—temporarily or permanently—from the wheels 31 of the front axle 30 and only used for energy generation via the generator 24. In addition, it would be possible for the battery units 20 to be dispensed with and the generator 24 directly coupled to the electric motor 12.

While representative embodiments are described above, it is not intended that these embodiments describe all possible forms of the claimed subject matter. The words used in the specification are words of description rather than limitation, and it is understood that various changes may be made without departing from the spirit and scope of the claimed subject matter.

What is claimed is:

1. A vehicle comprising:
a body;
an internal combustion engine;
a traction battery;
a front axle connecting two front wheels with at least one of the two front wheels drivingly coupled to the internal combustion engine;
a rear axle connecting two rear wheels and carried by two leaf spring units, each leaf spring unit being pivotably connected at one end to the body and at another end to a connection arm pivotably connected to the body, wherein the rear axle includes two driveshafts connecting the rear wheels; and
a drive unit supported by the rear axle to be self-supporting relative to the body, the drive unit comprising:
an electric motor coupled to the traction battery; and
a differential mechanically coupled to the two driveshafts and the electric motor.

2. The vehicle of claim 1 further comprising a drive housing containing the electric motor and the differential.

3. The vehicle of claim 2 further comprising two shaft housings connected to the drive housing, each shaft housing associated with, and at least partly containing, one of the two driveshafts.

4. The vehicle of claim 1 further comprising a second traction battery coupled to the electric motor, wherein the traction battery and the second traction battery are position on opposite sides of a longitudinal centerline of the vehicle.

5. The vehicle of claim 1 further comprising a generator mechanically coupled to the internal combustion engine and electrically coupled to the traction battery.

6. The vehicle of claim 1 wherein the drive unit further comprises a coupling to selectively disconnect the two driveshafts from the electric motor.

7. The vehicle of claim 1 wherein the drive unit comprises a first gear connected to the electric motor and a second gear coupling the first gear to the differential.

8. The vehicle of claim 7 wherein the second gear comprises a reduction gear.

9. The vehicle of claim 1 wherein the rear axle is mechanically uncoupled from the internal combustion engine.

10. A vehicle comprising:
a body;
a rear axle carried by two leaf spring units, each leaf spring unit pivotably connected to the body and to a connection arm pivotably connected to the body;
two driveshafts within the rear axle; and
a drive unit having a differential coupled to the two driveshafts and to an electric motor, wherein the drive unit is carried by the rear axle to be self-supporting relative to the body.

11. The vehicle of claim 10 further comprising:
a front axle; and
an internal combustion engine coupled to the front axle and mechanically uncoupled from the rear axle.

12. The vehicle of claim 11 further comprising a traction battery coupled to the electric motor.

13. The vehicle of claim 12 further comprising a generator coupled to the internal combustion engine and electrically coupled to the traction battery.

14. The vehicle of claim 12 further comprising a second traction battery coupled to the electric motor, wherein the traction battery and the second traction battery are positioned on opposite sides of a longitudinal center line of the vehicle.

15. The vehicle of claim 10 wherein the drive unit comprises a coupling to selectively disconnect at least one of the two driveshafts from the electric motor.

16. The vehicle of claim 10 wherein the drive unit comprises:
a first gear connected to the electric motor; and
a second gear coupling the first gear to the differential, wherein the second gear is a reduction gear.

17. A vehicle comprising:
an engine drivingly coupled to a front axle;
a rear axle coupled to a vehicle body by two leaf spring units and having two driveshafts; and
an electric motor coupled by a differential to the two driveshafts, wherein the electric motor is supported by the rear axle to be self-supporting relative to the vehicle body, wherein the engine is mechanically uncoupled from the rear axle.

18. The vehicle of claim 17 further comprising a traction battery coupled to the electric motor.

19. The vehicle of claim 17 further comprising a first gear connected to the electric motor, and a second gear coupled to the first gear and the differential.

20. The vehicle of claim 17 further comprising a coupling configured to selectively disconnect the electric motor from the two driveshafts.
